(19) United States
(12) Patent Application Publication
(10) Pub. No.: US 2024/0091721 A1
(43) Pub. Date: Mar. 21, 2024

(54) AERATOR

(71) Applicant: VLAHOGEORGE, Lafayett, IN (US)

(72) Inventor: John T. Vlahogeorge, Lafayette, IN (US)

(21) Appl. No.: 18/263,600

(22) PCT Filed: Jan. 28, 2022
(86) PCT No.: PCT/US2022/014328

§ 371 Date: Jul. 31, 2023

Related U.S. Application Data
(60) Provisional application No. 63/143,518, filed on Jan. 29, 2021.

(51) Int. Cl. B01F 23/232; A01K 63/04; B01F 23/231; B01F 23/237

(52) U.S. Cl. CPC B01F 23/232311; A01K 63/042; B01F 23/231151; B01F 23/237611; B01F 2101/305; B01F 2215/0422

(57) ABSTRACT

An apparatus to move and aerate liquid is disclosed. The apparatus includes a frustoconical base forming a gas chamber. The gas chamber includes one or more inner apertures to allow gas flow into a mixing chamber to aerate and, subsequently, move liquid into a liquid riser for subsequent movement back into the liquid supply. The gas chamber further includes one or more outer apertures to allow gas flow directly into liquid of the liquid supply surrounding the liquid riser. Preferably, the liquid exiting the liquid riser aids in dispersing the liquid aerated by the one or more outer apertures.

### BACKGROUND

When raising various animals including shrimp or fish in ponds or tanks, it is necessary to maintain the oxygen content of the water. As appreciated, however, various factors decrease the oxygen content. Thus, aerators have been used to help maintain a desired oxygen content of the water.

There are many kinds of aerators. For example, a bubbler aerator is a diffused air aeration system that releases air bubbles at the bottom of the pond or tank. The bubbles then rise upward towards the water top surface.

Typically, with many aerators, oxygen is unable to reach all areas of the pond or tank. For example, an aerator may release air bubbles at the bottom of the pond or tank but the bubbles may be limited to a particular radius due to dispersion. In especially large bodies of water, this prevents constant and equal oxygen concentrations throughout the pond or tank. To prevent this, multiple aerators may be needed, which increases cost and lowers efficiency.

Thus, there is a need for improvement in this field.

### SUMMARY

The present disclosure pertains to an aerator for use in ponds and/or tanks. As has been mentioned previously, when raising various animals including shrimp and/or fish, it is necessary to maintain the oxygen content of the liquid. The disclosed aerator increases the oxygen content of the liquid and helps to move water throughout at least a portion of the pond and/or lake.

In one aspect, the disclosed devices aerate and move oxygenated liquid, which creates liquid movement throughout the pond/tank. Movement of the liquid further assists in maintaining the pond/tank oxygen content as required by circulating oxygenated and deoxygenated liquid.

In another aspect, the aerator is a bubble aerator device. The aerator may be configured to supply oxygen directly into the liquid adjacent to (e.g., surrounding) the aerator. As should be appreciated, the disclosed aerators allow for increased oxygenation of the liquid contained in the pond/tank.

In a further aspect, the aerator may include a frustoconical base. The frustoconical base may be configured to include both interior and exterior apertures as well as a liquid flow channel. The interior apertures are configured to provide gas to a liquid while the exterior apertures are configured to supply gas to a surrounding liquid. The liquid flow channel is preferably configured to regulate the flow rate and/or velocity of the incoming liquid being moved through the aerator, thus regulating the gas/liquid mixture.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a diagrammatic view of an aerator.

FIG. 2 is a side view of a frustoconical base of the aerator of FIG. 1.

FIG. 3 is a top view of the frustoconical base of FIG. 2.

FIG. 4 is a cross-sectional view of the frustoconical base of FIG. 2 including a liquid transport device.

FIG. 5 is a perspective view of the frustoconical base of FIG. 2 mounted to the liquid transport device.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

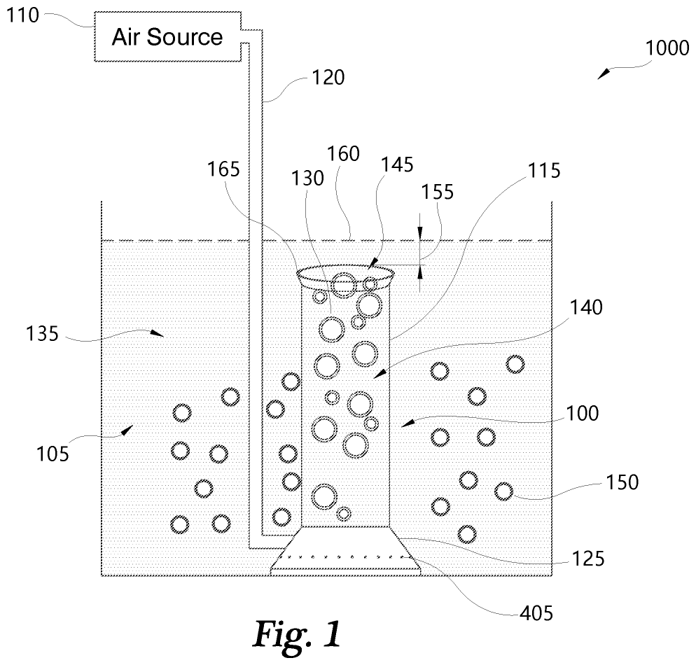

FIG. 1 shows an exemplary system 1000 of the present disclosure. The system includes an aerator 100, a liquid supply 105, and a gas (e.g., air) source 110. The liquid supply 105 is generally a body of water (e.g., lake, pond, tank, pool, reservoir, etc.). The gas source 110 is generally air and/or oxygen from a blower, compressor, and/or fan (e.g., a ducted fan), such as an electric blower. In some examples, the blower, compressor and/or fan is powered by renewable energy (e.g., windmill-powered and/or solar powered).

The aerator includes a liquid riser 115 extending vertically from a base 125 of the aerator. The liquid riser 115 is generally in the form of a tube and/or pipe. The liquid riser may be made from plastic; however, the liquid riser 115 may be formed from metal and/or other suitable materials. The liquid riser 115 generally includes a discharge opening 145 located at one end of the riser 115. The discharge opening 145 may be defined by a flared portion 165. The flared portion 165 generally has a larger diameter than the liquid riser 115. In one embodiment, the discharge opening 145 of the liquid riser 115 is positioned a predetermined distance 155 below a surface 160 of the liquid supply 105. The predetermined distance 155 is preferably greater than a cross-sectional dimension of the discharge opening 145 of the riser. In one example, the predetermined distance 155 is between 6 inches and 24 inches. In another example, the predetermined distance 155 is 12 inches.

The liquid riser 115 is shown to include a wall thickness 430 and a diameter 425. The wall thickness 430 may be based on the intended usage. For example, schedule 40 pipe may be used for applications involving lower pressures. In another example, schedule 80 pipe may be used for applications requiring higher pressures. The diameter 425 of the pipe may be variable based on a desired output from the aerator 100. For example, a larger diameter 425 may be used if a higher output is desired and a smaller diameter 425 may be used if a lower output is desired. In one example, the diameter 425 is between 6 inches and 24 inches. In another example, the diameter 425 is approximately 12 inches.

Extending from the gas source 110 is a gas conduit 120. The gas conduit 120 (e.g., hose, and/or pipe) is configured to route the gas from the gas source 110 to the base 125. In preferred embodiments, the gas conduit 120 is highly flexible. In one example, the gas conduit 120 comprises a rubber and/or plastic material. It will be appreciated, however, that the gas conduit may comprise metal.

The base 125 may be a frustoconical base. However, the base 125 may be other shapes as desired by a user. For example, the base 125 may be pyramidal, conical, rectangular, polygonal, and/or other shapes. As has been mentioned previously, the base 125 receives gas from the gas conduit 120. The base 125 is pressurized by the incoming gas and the pressure forces the gas out of the base 125 through one or more predetermined paths. In one embodiment, the gas has multiple paths to exit the base 125.

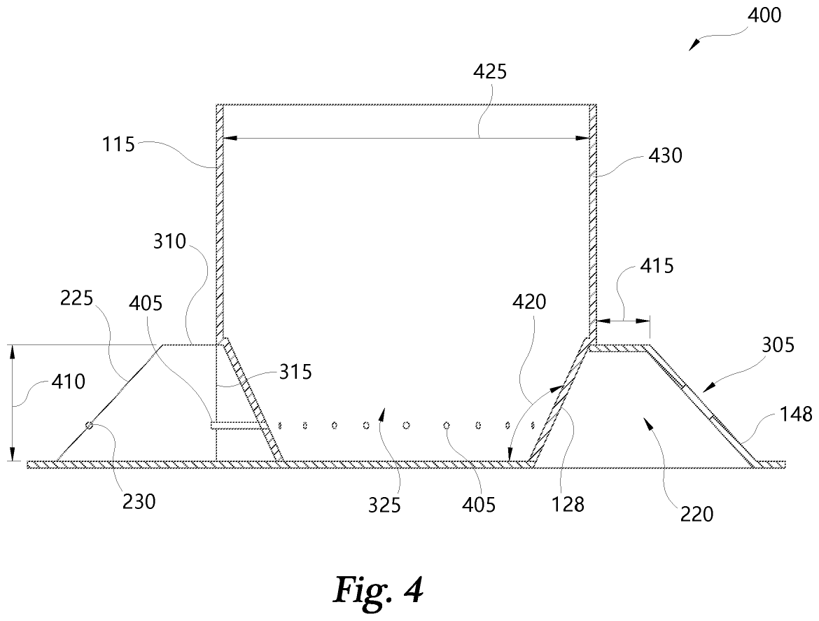

In one path, the gas escapes through an interior wall 128 (see FIG. 4) of the base 125 and into the liquid riser 115 in the form of one or more bubbles 130. The bubbles 130 mix with a liquid 135 to form a gas-liquid mixture 140. The gas-liquid mixture 140 is less dense than the liquid 135 and thus rises quickly through the liquid riser 115 until discharged at the discharge opening 145. As should be appreciated, the liquid exits the discharge opening 145 with enough force to disturb liquid in the liquid supply 105 (e.g., body of water) outside of the discharge opening. The disturbance assists in spreading the newly oxygenated liquid throughout the liquid supply 105 (e.g., body of water) as well as mixing the oxygenated and deoxygenated liquid to maintain an equilibrium. As should be appreciated, the flared portion 165 assists in spreading the gas-liquid mixture 140 throughout the surrounding liquid.

In another path, the gas escapes through an exterior wall 148 (see FIG. 4) of the base 125 and into the surrounding liquid 135. As the gas escapes the exterior of the base 125, the gas forms one or more bubbles 150. The bubbles 150 disperse throughout the liquid 135, thus aerating the area surrounding the aerator 100. As should be appreciated, the gas-liquid mixture is less dense than the surrounding liquid, which causes the gas-liquid mixture to rise towards the surface of the liquid supply 105 (e.g., body of water). As the gas-liquid mixture rises, the denser liquid 135 is displaced and moves downwards towards the bottom where the denser liquid 135 is aerated.

The paths described above are not mutually exclusive, meaning that the aerator 100 is configured to perform a water movement as well as simultaneously aerate the liquid supply 105 (e.g., body of water) surrounding the riser. The surrounding liquid 135 is generally fresh and/or salt water. In other examples, the liquid 135 may be a water mixture. The water may be mixed with sewage and/or sediment.

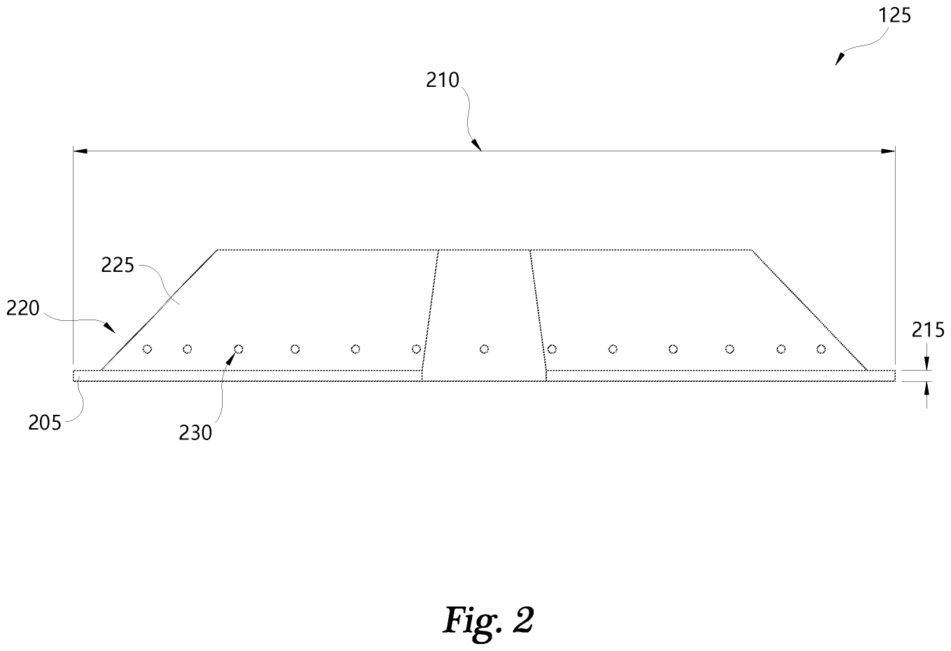

FIG. 2 shows an example of the base 125 of FIG. 1. Generally, the base 125 includes a plate 205. The plate 205 is configured to support the base 125 during use. The plate 205 may assist in preventing the aerator 100 from tipping over in the liquid supply 105 (e.g., body of water). The plate may also have sufficient mass and density to resist buoyancy of the device when operating in a liquid supply 105. Preferably, the plate may have a sufficient mass and density to prevent the aerator from floating and/or moving in the liquid supply 105 during operation. The plate may comprise a polymer and/or metal material. The plate 205 may be circular. However, in other examples, the plate 205 may be rectangular, triangular, and/or polygonal.

As shown in FIG. 2 the plate 205 has a width 210 and a thickness 215. As was explained above, the width 210 may be equivalent to a diameter in circular plate configurations. In one example, the width 205 is between 30 and 50 inches. The width 210 may be larger or smaller depending on the application. For example, the width 210 may be larger to provide a sturdier base in environments with greater liquid flow. In another example, the width 210 may be smaller to reduce the overall size and area taken up by the aerator 100.

The thickness 215 may be less than 1 inch. The thickness 215 may be configured for the particular use of the aerator 100. For example, the thickness 215 may be greater to provide a more rigid plate 205. In another example, the thickness 215 may be lesser to decrease the weight of the aerator 100.

Base 125 includes a gas chamber 220. The gas chamber may be mounted to the plate 205. The gas chamber 220 has an exterior wall having an outer surface 225 defining a plurality of apertures 230. In one embodiment, the gas chamber 220 and the plate 205 are a unitary structure. For example, the gas chamber 220 and plate 205 are a molded polymeric material. In another embodiment, the gas chamber 220 and the plate 205 are separate components held together by the use of one or more fasteners. The one or more fasteners may be rivets, adhesive, bolts, screws, and/or epoxy.

The plurality of apertures 230 of the gas chamber 220 are preferably arranged to direct the gas exiting the plurality of apertures 230 upwards and outwards from the base and the liquid riser. Such an arrangement may be achieved by the plurality of apertures being defined by the outer surface 225 and the outer surface being angled relative to the bottom of the gas chamber. The angle of the plurality of apertures and/or outer surface 225 may be configured for different use cases. In an example embodiment, the angle of the outer surface of the gas chamber relative to the plate is between 40 and 50 degrees.

The plurality of apertures 230 are preferably spaced along an outer circumference of the outer surface 225. The apertures 230 are configured to release gas from inside of the gas chamber 220. As the pressure inside of the gas chamber 220 increases, gas is forced from an area of high pressure (gas chamber) through the apertures 230 and into the surrounding liquid as bubbles 150. The bubbles 150 oxygenate the surrounding liquid and assist in maintaining to the oxygen content of the liquid supply 105.

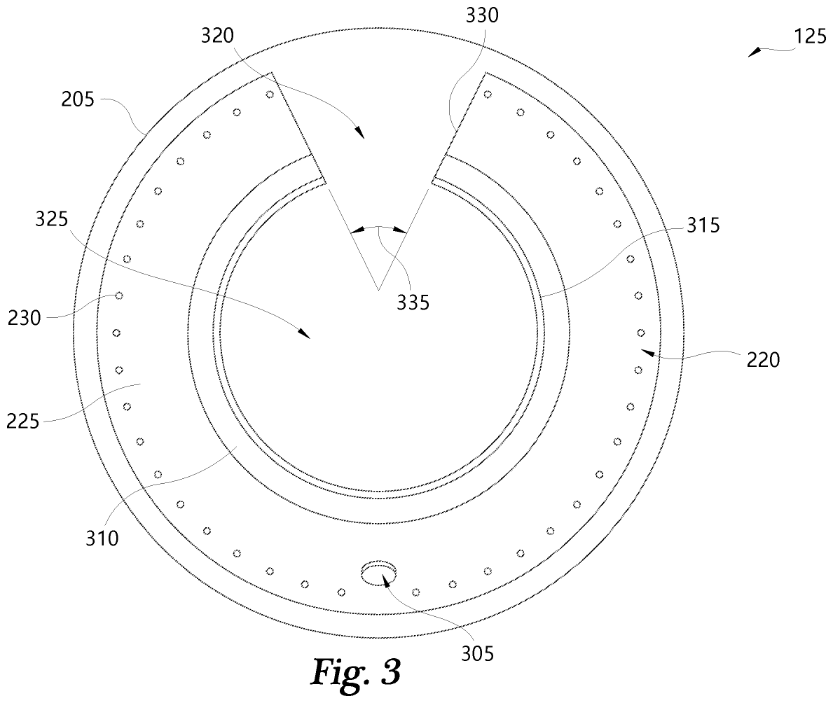

FIG. 3 show-s a top down view of the base 125. The base 125 is shown to further include a gas inlet 305. The gas inlet 305 may be located on the outer surface 225 of the gas chamber 220. The gas inlet 305 is configured to receive the gas conduit 120. For example, the gas conduit 120 may mount to the gas inlet 305 by threads, adhesive, snap fit, and/or other mounting fasteners. As should be appreciated, the gas conduit 120 supplies gas from the gas blower, compressor, or fan 110 to the gas chamber 220 through the gas inlet 305.

The base 125 may include a plateau 310. The plateau 310 may be configured to receive and support the liquid riser 115. The interior wall of base 125 defines an inner surface 315 facing away from the outer surface of the base. In one embodiment, the inner surface 315 is set at a radial distance of about 10 inches from a center of the frustoconical base 125 while the outer surface is set at a radial distance of about 20 inches from the center of the frustoconical base 125.

As can been seen from the top view in FIG. 3, the gas chamber 220 may define a liquid channel 320 arranged to allow liquid to pass from a region radially outward of the device into a central section of the device comprising a mixing region 325. The liquid channel 320 may be configured to regulate the flow of liquid from the liquid supply 105 into the mixing region 325. In some aspects, the liquid channel 320 may have one or more non-parallel surfaces 330 configured to accelerate and/or decelerate the velocity of liquid passing to the mixing region 325. The non-parallel surfaces 330 may define planes that intersect at an angle 335. In one example, the angle 335 is between 15 degrees and 60 degrees. In another example, the angle 335 is between 25 degrees and 50 degrees. In yet another example, the angle is about 30 degrees. In one example, the surfaces 330 are angled towards one another along the direction of flow (e.g., an outward-to-inward direction) so that the opening has a smaller cross-sectional area at the inner surface of the base than at the outer surface. Advantageously, such an arrangement may increase the velocity of the liquid entering the mixing region and/or liquid riser which may increase aeration and/or turbulence. In another example, the surfaces 330 may diverge so as to decrease the velocity of the liquid passing through the liquid channel.

Liquid from the liquid supply 105 and gas from the gas chamber 220 meet in the mixing region 325. The mixing region 325 creates an aerated liquid having a density lesser than that of other liquid in and/or around the aerator. Accordingly, the aerated liquid travels upwards through the liquid riser 115 before exiting and returning to the liquid supply 105 as aerated liquid.

Shown in FIG. 4 is a cross-sectional view of the base with liquid riser 400. The inner surface 315 is shown to include a plurality of apertures 405. The apertures 405 work similarly to the apertures 230. For example, when the gas chamber 220 is substantially filled with gas from the gas conduit 120 gas is released through the apertures 405 into the mixing region 325. In this manner, the base 125 both moves water (through the apertures 405) and aerates (through the apertures 230).

The device may be arranged to release more gas from the inner surface than the outer surface and/or vice versa. Similarly, the device may be arranged to release bubbles of different size from the inner surface than the outer surface. Apertures of the inner surface and the outer surface may have the same or different hydraulic diameter (e.g., cross-sectional area). For example, apertures of the inner surface may have a larger hydraulic diameter than apertures of the outer surface. Similarly, apertures of the inner surface and the outer surface may have the same shape (e.g., circular) and/or different shapes. For example, apertures of the inner surface may comprise elongate slots and apertures of the outer surface may not comprise elongate slots.

The base 125 is shown to include a height 410. The height 410 may be configured for the intended usage. For example, the height 410 may be configured to position certain apertures at least a certain height above the bottom of the liquid supply 105 (e.g., above the plate). Similarly, the height and/or width of the base may be configured to define a particular volume for the mixing region 325. In one embodiment, the height 410 is less than about 10 inches. The plateau 310 is shown to include a width 415. The width 415 is generally about 2 inches.

Apertures of the inner surface may be located at the same or a different height above the plate than apertures of the outer surface. For example, apertures of the inner surface may be located closer to the plate than apertures of the outer surface or vice versa. One or more apertures of the inner surface may also be at a different height than other apertures of the inner surface, and or one or more apertures of the outer surface may be at a different height that other apertures of the outer surface.

In some embodiments, the inner apertures and or inner surface 315 of the base 125 is angled relative to the bottom of the base (e.g., the plate). The angle 420 may be configured depending on the intended usage. For example, an angle 420 less than 90 degrees may be used to direct gas exiting the inner apertures inwardly and downwardly in the mixing region. Such an arrangement may advantageously increase turbulence in the mixing region 325. In other embodiments, the angle may be greater than 90 degrees so as to direct gas exiting the inner apertures and inner surface inwardly and upwardly. Advantageously, blowing gas in the direction of fluid movement may improve the upward velocity of the gas-liquid mixture 140.

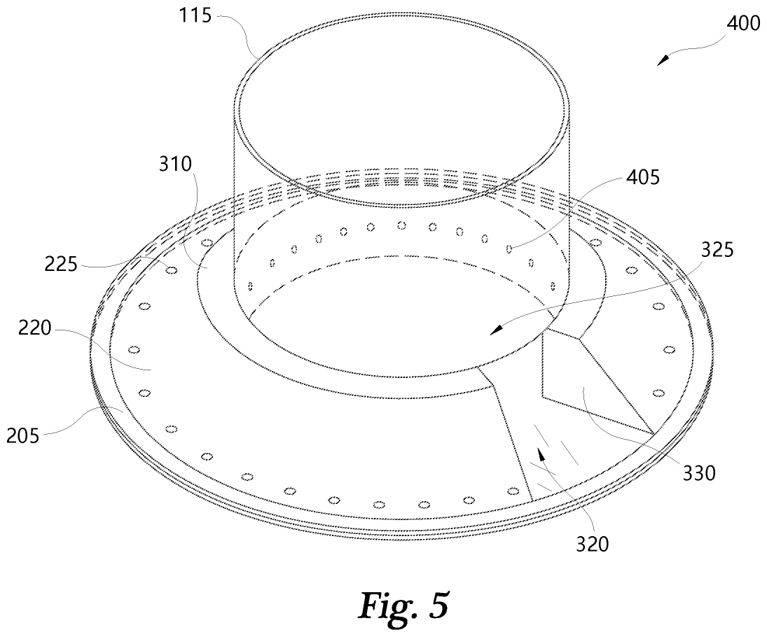

FIG. 5 shows an example of the base combined with the liquid riser 400. Generally, the base 125 and liquid riser 115 are configured as separate components and secured together by a fastener. The fastener may be adhesive, rivets, bolts, screws, welds, snap-fit, friction fit, and/or epoxy. In other examples, the base 125 and the liquid riser 115 are a unitary structure without the need for fasteners. In some instances, an outer diameter of the liquid riser 115 may correspond with an inner diameter of the base defined by the inner surface 315 such that the liquid riser may be received radially within the inner surface 315. In such instances, the liquid riser may be secured within the base by friction fit. Alternatively or additionally, the liquid riser 115 may be held within the inner surface 315 via adhesive, screws, welds, and or epoxy.

In FIG. 5, the liquid channel 320 is shown in more detail. As can be seen, the liquid channel 320 is configured to accept liquid from the liquid supply 105 and direct the liquid into the mixing portion 325 via the surfaces 330. As was discussed previously, the surfaces 330 may be angled inwards to increase the velocity of the incoming liquid. Additionally or alternatively, the surfaces 330 may be angled from vertical (e.g., relative to the plate) to further assist in directing liquid into the liquid channel 320. In one embodiment, the surfaces 330 are angled about 5 degrees from vertical.

The distance between surfaces 330 may be configured to achieve a desired volumetric flow rate of water into the mixing chamber. In some instances, the distance between the surfaces may about 5 inches. The number and/or size of the inner apertures and the pressure and/or volume of gas supplied to the gas chamber may also be configured for a particular flow rate.

As is illustrated in FIG. 5, the aerator 100 is configured to both move and aerate liquid. For example, liquid from the liquid supply 105 is directed into the mixing region 325 and mixed with gas from the gas chamber 220. The gas-liquid mixture 140 is then less dense than the surrounding liquid and moves upwards to exit the device and return to the liquid supply 105. Simultaneously, gas escapes the gas chamber 220 through one or more apertures 225 and mixes with the surrounding liquid to aerate the liquid supply 105.

An upper opening of the liquid riser is positioned below the upper surface of the liquid supply. Advantageously, such an arrangement helps disperse liquid aerated by the one or more outer apertures away from the liquid riser. In some arrangements, the liquid riser may have a flow director (e.g., a 90 degree bend) to direct water flow in one or more directions (e.g., non-orthogonal to the upper surface of the liquid supply, parallel to the upper surface of the liquid supply). The upper opening of the liquid riser may be positioned above the upper surface of the liquid supply.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

The following numbered clauses set out specific embodiments that may be useful in understanding the present invention:
1. An aerator, comprising:
   a gas source;
   a liquid supply;
   a base having a gas chamber, wherein the gas chamber has an inner surface and an outer surface, the inner surface defining a mixing chamber;
   a gas conduit extending from the gas source to the gas chamber to supply gas from the gas source into the gas chamber;
   wherein the inner surface has one or more apertures configured to release gas from the gas chamber into the mixing chamber to aerate liquid from the liquid supply in the mixing chamber; and
   a liquid riser extending above the mixing chamber of the base to convey aerated water away from the mixing chamber, and wherein the outer surface of the gas chamber has one or more apertures configured to release gas from the gas chamber into liquid from the liquid supply positioned around the liquid riser so as to aerate the liquid positioned around the liquid riser.
2. The aerator of clause 1, wherein the liquid riser has an upper opening positioned to beneath a top surface of the liquid supply.
3. The aerator of any preceding clause, wherein the one or more apertures of the outer surface are angled upward and away from the base when the base is positioned in the liquid supply.
4. The aerator of any preceding clause, wherein the angle of the outer surface is between 40 and 50 degrees.
5. The aerator of any preceding clause, wherein the one or more apertures of the inner surface are angled upward and inward relative to the base when the base is positioned in the liquid supply.
6. The aerator of any preceding clause, wherein the gas chamber defines an opening arranged to allow liquid to pass from a region radially outward of the gas chamber into the mixing chamber.
7. The aerator of any preceding clause, wherein a cross-sectional area of the opening is less than a cross-sectional area of the liquid riser.
8. The aerator of any preceding clause, wherein the opening has converging opposing
surfaces along an outward-to-inward direction so that the opening has a smaller cross-sectional area at the inner surface of the gas chamber than at the outer surface.
9. The aerator of any preceding clause, further comprising:
   a plate;
   wherein the plate serves as a mounting location for the gas chamber; and wherein a circumference of the plate is larger than a circumference of the gas chamber.
10. The aerator of any preceding clause, wherein the plate has a mass and a density, and wherein the mass and density are sufficient to overcome a buoyancy force of the liquid supply.
11. The aerator of any preceding clause, wherein the base defines a frustoconical shape, wherein a lower portion of the base has a larger diameter than an upper portion of the base.
12. An aerator, comprising:
   a gas source;
   a liquid supply;
   a base having a gas chamber, wherein the gas chamber has an inner surface and an outer surface, the inner surface defining a mixing chamber;
   a gas conduit extending from the gas source to the gas chamber to supply gas from the gas source into the gas chamber;
   wherein the gas chamber defines an opening arranged to allow liquid to pass from a region radially outward of the gas chamber into the mixing chamber; and
   wherein the opening has converging opposing surfaces along an outward-to-inward direction so that the opening has a smaller cross-sectional area at the inner surface of the gas chamber than at the outer surface.
13. The aerator of clause 12, further comprising:
   a liquid riser;
   wherein the liquid riser extends above the mixing chamber of the base to convey aerated water away from the mixing chamber.
14. The aerator of any of clauses 12-13, wherein the outer surface of the gas chamber has one or more apertures configured to release gas from the gas chamber into liquid from the liquid supply positioned around the liquid riser so as to aerate the liquid positioned around the liquid riser.
15. The aerator of any of clauses 12-14, wherein the one or more apertures of the outer surface are angled upward and away from the base when the base is positioned in the liquid supply.
16. The aerator of any of clauses 12-15, wherein the angle of the outer surface is between 40 and 50 degrees.
17. The aerator of any of clauses 12-16, wherein the inner surface has one or more apertures configured to release gas from the gas chamber into the mixing chamber to aerate liquid from the liquid supply in the mixing chamber.
18. The aerator of any of clauses 12-17, wherein the one or more apertures of the inner surface are angled upward and inward relative to the base when the base is positioned in the liquid supply.
19. The aerator of any of clauses 12-18, further comprising:
   a plate supporting the gas chamber; and
   wherein a circumference of the plate is larger than a circumference of the gas chamber.
20. The aerator of any of clauses 12-19, wherein the plate has a mass and a density, and wherein the mass and density are sufficient to overcome a buoyancy force of the aerator during operation.

1. An aerator, comprising:
a gas source;
a liquid supply;
a base having a gas chamber, wherein the gas chamber has an inner surface and an outer surface, the inner surface defining a mixing chamber;
a gas conduit extending from the gas source to the gas chamber to supply gas from the gas source into the gas chamber;
wherein the inner surface has one or more apertures configured to release gas from the gas chamber into the mixing chamber to aerate liquid from the liquid supply in the mixing chamber; and
a liquid riser extending above the mixing chamber of the base to convey aerated water away from the mixing chamber; and
wherein the outer surface of the gas chamber has one or more apertures configured to release gas from the gas chamber into liquid from the liquid supply positioned around the liquid riser so as to aerate the liquid positioned around the liquid riser.

2. The aerator of claim 1, wherein the liquid riser has an upper opening positioned beneath a top surface of the liquid supply.

3. The aerator of claim 1, wherein the one or more apertures of the outer surface are angled upward and away from the base when the base is positioned in the liquid supply.

4. The aerator of claim 3, wherein the angle of the outer surface is between 40 and 50 degrees.

5. The aerator of claim 1, wherein the one or more apertures of the inner surface are angled upward and inward relative to the base when the base is positioned in the liquid supply.

6. The aerator of claim 1, wherein the gas chamber defines an opening arranged to allow liquid to pass from a region radially outward of the gas chamber into the mixing chamber.

7. The aerator of claim 6, wherein a cross-sectional area of the opening is less than a cross-sectional area of the liquid riser.

8. The aerator of claim 7, wherein the opening has converging opposing surfaces along an outward-to-inward direction so that the opening has a smaller cross-sectional area at the inner surface of the gas chamber than at the outer surface.

9. The aerator of claim 1, further comprising:
a plate;
wherein the plate serves as a mounting location for the gas chamber, and
wherein a circumference of the plate is larger than a circumference of the gas chamber.

10. The aerator of claim 9, wherein the plate has a mass and a density, and wherein the mass and density are sufficient to overcome a buoyancy force of the liquid supply.

11. The aerator of claim 1, wherein the base defines a frustoconical shape, wherein a lower portion of the base has a larger diameter than an upper portion of the base.

12. An aerator, comprising:
a gas source;
a liquid supply;
a base having a gas chamber, wherein the gas chamber has an inner surface and an outer surface, the inner surface defining a mixing chamber;
a gas conduit extending from the gas source to the gas chamber to supply gas from the gas source into the gas chamber;
wherein the gas chamber defines an opening arranged to allow liquid to pass from a region radially outward of the gas chamber into the mixing chamber; and
wherein the opening has converging opposing surfaces along an outward-to-inward direction so that the opening has a smaller cross-sectional area at the inner surface of the gas chamber than at the outer surface.

13. The aerator of claim 12, further comprising:
a liquid riser;
wherein the liquid riser extends above the mixing chamber of the base to convey aerated water away from the mixing chamber.

14. The aerator of claim 13, wherein the outer surface of the gas chamber has one or more apertures configured to release gas from the gas chamber into liquid from the liquid supply positioned around the liquid riser so as to aerate the liquid positioned around the liquid riser.

15. The aerator of claim 14, wherein the one or more apertures of the outer surface are angled upward and away from the base when the base is positioned in the liquid supply.

16. The aerator of claim 15, wherein the angle of the outer surface is between 40 and 50 degrees.

17. The aerator of claim 12, wherein the inner surface has one or more apertures configured to release gas from the gas chamber into the mixing chamber to aerate liquid from the liquid supply in the mixing chamber.

18. The aerator of claim 17, wherein the one or more apertures of the inner surface are angled upward and inward relative to the base when the base is positioned in the liquid supply.

19. The aerator of claim 12, further comprising:
a plate supporting the gas chamber, and
wherein a circumference of the plate is larger than a circumference of the gas chamber.

20. The aerator of claim 19, wherein the plate has a mass and a density, and wherein the mass and density are sufficient to overcome a buoyancy force of the aerator during operation.
